(19) United States
(12) Patent Application Publication
(10) Pub. No.: US 2011/0158861 A1
(43) Pub. Date: Jun. 30, 2011

(54) VOLATILITY-TYPE ISOLATION AND PURIFICATION DEVICE

(75) Inventors: CHIH-SHENG YU, HSINCHU CITY (TW); YI-CHIUEM HU, HSINCHU CITY (TW); FANG-GANG TSENG, HSINCHU CITY (TW)

(73) Assignee: NATIONAL APPLIED RESEARCH LABORATORIES, TAIPEI CITY (TW)

(21) Appl. No.: 12/703,208

(22) Filed: Feb. 10, 2010

(30) Foreign Application Priority Data
Dec. 29, 2009 (TW) 098145669

(51) Int. Cl. B01D 12/00

(52) U.S. Cl. 422/261; 977/700

(57) ABSTRACT

The present invention discloses a volatility-type isolation and purification device comprising a substrate and at least one separation region. The surface of the at least one separation region comprises at least one immobilization layer. When a mixture solution comprising at least one substance to be separated is dropped on the at least one separation region, the substances to be separated each is immobilized on the immobilization layer respectively by the volatility or hysteresis of the mixture solution itself.

### FIELD OF THE INVENTION

The present invention relates to an isolation and purification device; and more particularly, to a volatility-type isolation and purification device.

### BACKGROUND OF THE INVENTION

Purification and isolation of biological molecules play an important role in a biomedical field. However, during a purification process, it needs to take longer preparation time and perform multifarious steps. In recent years, after a concept of a Lab-on-a-chip was proposed along with the improvement of the microelectromechanical system (MEMS), miniaturization features are used to simplify multifarious and complicated steps in many laboratories so as to decrease operation problems and pollution problems. In general, an analysis and detection procedure comprises the steps of sample extraction, polymer cycle reaction (PCR), and electrophoresis. However, each of the aforementioned steps is independent and time-consuming. Therefore, the miniaturization features play an important role in quick detection and microanalysis.

Generally, in an isolation and purification process, liquids are used as media for transmitting samples to be separated to a certain region for separating and analyzing. In order to transmit the liquid, a force, such as a pump, electricity, magnetism and so on, must be externally applied. A chromatography method which is one example using the pump to drive the liquid t flow is usually applied in purification and isolation technical fields. The kinds of the chromatography method comprise a liquid chromatography method, a gas chromatography method, a high performance thin-layer chromatography (HPTLC) method, and a supercritical fluid chromatography method.

The aforementioned procedures can be minimized in a chip, e.g. micro-fluidic chip, by the MEMS technology. Nevertheless, for current separation technology, there is still needed the external force used as a power of driving liquid transmission. For example, an external unit provided as a power of driving liquid transmission is disposed on a separation device. Therefore, the added unit will increase the difficulty in chip miniaturization manufacture, such as the package of the micro-fluidic chip.

### SUMMARY OF THE INVENTION

In view of the aforementioned drawbacks in prior art, an object of the present invention is to provide a volatility-type isolation and purification device, such that at least one substance to be separated in a mixture solution can be separated and purified respectively in short time by means of a driving force of the mixture solution during volatilization.

To achieve the above object, the volatility-type isolation and purification device according to the present invention comprises a substrate and at least one separation region. The at least one separation region is disposed on the substrate, and a surface of the at least one separation region comprises at least one immobilization layer. When a mixture solution comprising at least one substance to be separated is dropped on the at least one separation region, the at least one substance to be separated each is immobilized on the at least one immobilization layer respectively by the volatility or hysteresis of the mixture solution itself.

Wherein, the at least one immobilization layer may comprise a component selected from the group of an enzyme, an antigen, an antibody, a nucleic acid, a ligand, a receptor, a peptide, a protein, a biological material and a chemical material reacted with the substance to be separated. Additionally, a material of the substrate may comprise a silicon, a glass, a nylon, a polymer, or a ceramic.

Wherein, a material of the at least one separation region may comprise a metal, a glass, a nylon, a polymer or a ceramic. Moreover, said metal may comprise gold, nickel or cobalt. Additionally, a particle size of the metal comprises a microstructure, a nanostructure or a nano-microstructure.

Accordingly, the volatility-type isolation and purification device according to the present invention provides one or more of the following advantages:

(1) In the volatility-type isolation and purification device according to the present invention, a flow of a mixture solution is driven by a driving force of the mixture solution during volatilization to pass through the designed separation region. Thus, at least one sample to be detected is separated by the driving force. That is unnecessary to additionally impose other forces on the volatility-type isolation and purification device so as to drive the flow of the mixture solution.

(2) At least one substance to be separated in a mixture solution can be driven to adhere selectively to the designed separation region of the volatility-type isolation and purification device according to the present invention, further, so as to complete purification and isolation.

(3) Isolation and purification of a mixture solution is able to be completed in a short time by volatility of a droplet with micro-volumes via the volatility-type isolation and purification device with its own minimization feature.

### BRIEF DESCRIPTION OF THE DRAWINGS

The structure and the technical means adopted by the present invention to achieve the above object can be best understood by referring to the following detailed description of the preferred embodiments and the accompanying drawings, wherein

FIG. 1 is a schematic diagram illustrating a volatility-type isolation and purification device according to an embodiment of the present invention;

FIG. 2A is a first state diagram illustrating an isolation and purification of a volatility-type isolation and purification device according to an embodiment of the present invention;

FIG. 2B is a second state diagram illustrating the isolation and purification of the volatility-type isolation and purification device according to the embodiment of the present invention;

FIG. 2C is a third state diagram illustrating the isolation and purification of the volatility-type isolation and purification device according to the embodiment of the present invention;

FIG. 2D is a fourth state diagram illustrating the isolation and purification of the volatility-type isolation and purification device according to the embodiment of the present invention;

FIG. 3 is a side view illustrating a volatility-type isolation and purification device according to another embodiment of the present invention;

FIG. 4 is a schematic diagram illustrating at least one separation region in a volatility-type isolation and purification device according to an embodiment of the present invention; and

FIG. 5 shows fluorescence microscope images illustrating synthetic thiol-DNA labeled with FITC and synthetic amino-DNA labeled with TAMRA, which respectively immobilize on separation regions of a volatility-type isolation and purification device according to the present invention.

### DETAILED DESCRIPTION OF THE PREFERRED EMBODIMENTS

The present invention will now be described with some preferred embodiments thereof with reference to the accompanying drawings. It is understood the experimental data shown in the embodiments are provided only for easy interpretation of the technical means of the present invention and should in no means be considered as restriction to the present invention.

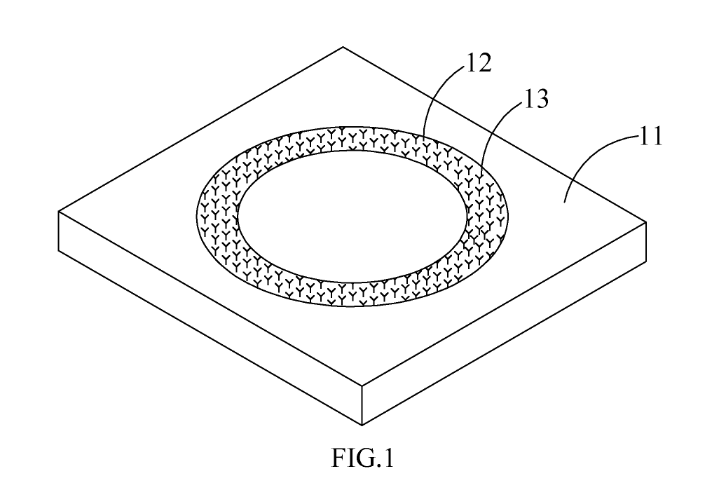

Please refer to FIG. 1, a schematic diagram illustrating a volatility-type isolation and purification device according to an embodiment of the present invention is shown. The volatility-type isolation and purification device comprises a substrate 11 and at least one separation region 12. The at least one separation region 12 is disposed on the substrate 11, and a surface of the at least one separation region 12 comprises at least one immobilization layer 13. When a mixture solution 21 comprising at least one substance to be separated is dropped on the at least one separation region 12, the at least one substance to be separated each is immobilized on the immobilization layer 13 respectively by the volatility or hysteresis of the mixture solution itself.

When a solution is dropped on a solid surface to form a droplet, the droplet will begin to evaporate from the edge of the droplet because the volatility speed of the edge of the droplet is larger than that of a center of the droplet during the volatilization process. However, because the edge of the droplet is immobilized on the original position, the inner portion of the droplet is continuously supplied to the edge of the droplet while the droplet is evaporated, thereby causing that the height of the droplet is decreased to further form a flow field inside the droplet.

The intensity of the thermal convection can be calculated by the Marangoni number formula during the volatilization process. When a surface temperature at the top of the droplet is different from a surface temperature at the bottom of the droplet, the Marangoni convection can be generated in the inner portion of the droplet. Therefore, according to above description, when the droplet is continuously evaporated, at the least one substance to be separated in the inner portion of the droplet will be flowed to the designed surface.

In addition, during the volatilization process, the mixture solution 21 is immobilized on the original position at the beginning. However, as time goes by, effects of the volatilization states are different. The volatilization process can be classified into three states. In the first state, a connecting area between a solution and a solid is stationary, but, at this moment, the height of the solution is decreased. In the second state, the height of the solution is stationary, but the connecting area between the solution and the solid is reduced. In other words, the edge of the solution is moved to the center of the solution due to the volatility power itself. The third state is a mixture mechanism combined with the first state and the second state. Therefore, the connecting area between the solution and the solid is reduced due to the volatilization of the solution. Because the volatility speed of the edge of the solution is larger than that of the center, it is easy to cause the so-called coffee ring effect. Additionally, a flow field is caused by temperature differences between the edge and the center of the solution such that particles are easy to be accumulated at the edge of the original position. For the reasons, particles suspended in a mixture droplet are driven to flow through the surface of the solid to the edge of the solid; finally, the particles can be immobilized on the edged of the solid due to the volatility effect.

The at least one immobilization layer 13 may comprise a component selected from the group of an enzyme, an antigen, an antibody, a nucleic acid, a ligand, a receptor, a peptide, a protein, a biological material and a chemical material reacted with the substance to be separated. A material of the substrate may comprise a silicon, a glass, a nylon, a polymer, or a ceramic. A material of the at least one separation region may comprise a metal, a glass, a nylon, a polymer or a ceramic, and can further comprise a self-assembly monolayer (SAM). Said metal may comprise gold, nickel or cobalt. If the material of the metal is increased on the at least one separation region, the isolation effect can be better. A particle size of the metal comprises a microstructure, a nanostructure or a nano-microstructure. Furthermore, a shape of the at least one separation region 12 comprises a circle, an oblong, a triangle, a rectangle, or an irregular shape.

The separation region 12 may comprise a silicon, a glass, a nylon, a polymer, or a ceramic, and is defined by the substrate 11 via the microelectromechanical process, thereby completing a micro-structure or a nano-structure on the immobilization layer 13 of the separation region 12. The volatility-type isolation and purification device according the present invention can purify and isolate DNA, RNA, a peptide, a protein, or a substance to be separated and combined with the immobilization layer 13.

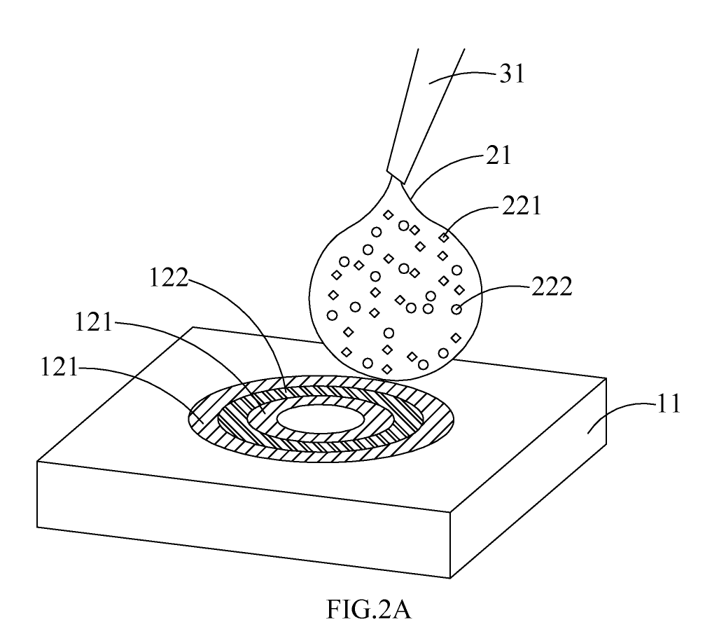

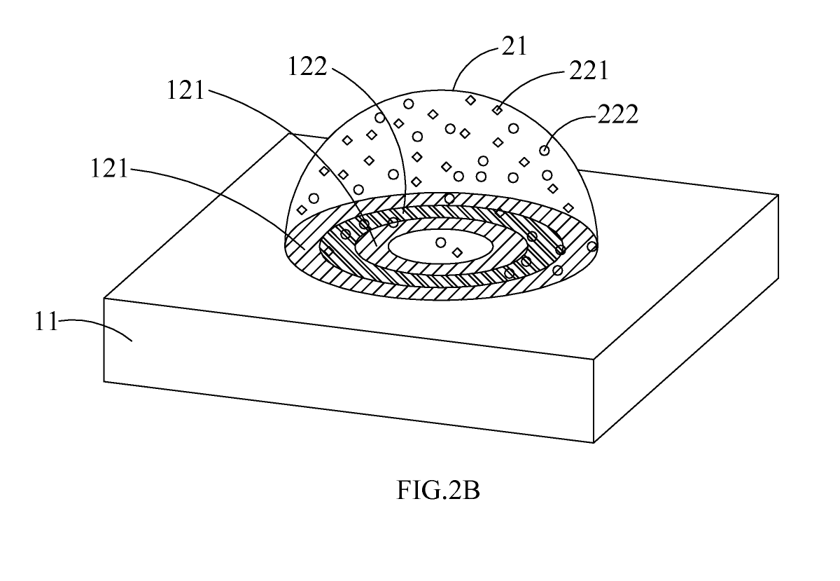

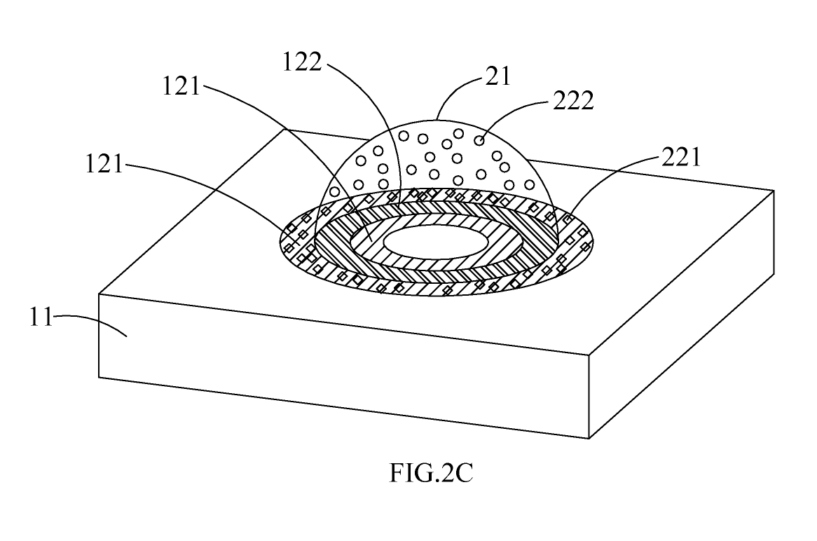

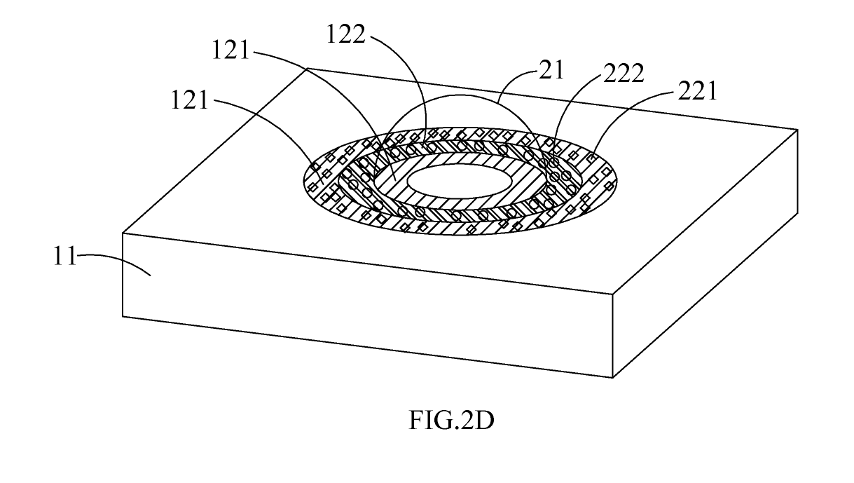

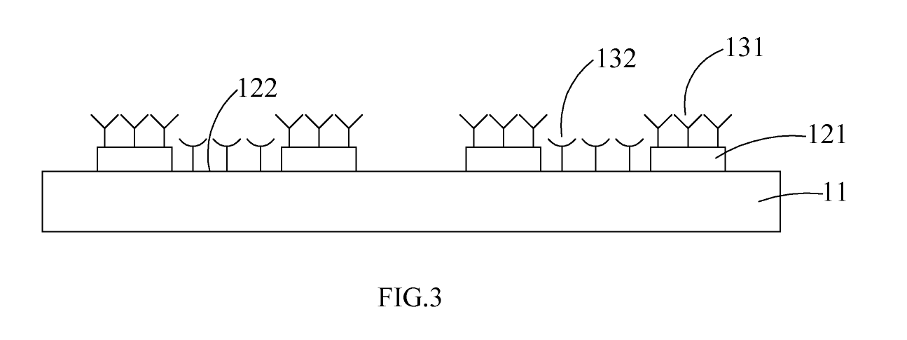

Please refer to FIGS. 2A, 2B, 2C, and 2D that are a first state diagram, a second state diagram, a third state diagram, and a forth state diagram illustrating the isolation and purification of the volatility-type isolation and purification device, respectively. The mixture solution 21 comprises first substances to be separated 221 and second substances to be separated 222. A first immobilization layer 131 and a second immobilization layer 132 are respectively disposed on a surface of a first separation region 121 and a surface of a second separation region 122 in the volatility-type isolation and purification device according to the present invention, as shown in FIG. 3. The above-described substances to be separated can be respectively immobilized on the first immobilization layer 131 and the second immobilization layer 132 with specific binding. When the mixture solution 21 is dropped by a dropper 31, the edge of the mixture solution 21 is immobilized on the border of the first separation region 121. When the mixture solution 21 is begun to evaporate, the whole mixture solution 21 will be became smaller. In the meanwhile, the first substances to be separated 212 are immobilized on the first immobilization layer 131 on the first separation region 121 with the specific binding. Additionally, the mixture solution 21 is continuously to evaporate, and to drive the edge of the mixture solution 21 shifting to the center. When the edge of the mixture solution 21 is shifted over the second separation region 122, the second substances to be separated 222 are immobilized on the second immobilization layer 132 of the second separation region 122 due to the specific binding. Finally, the first substances to be separated 212 and the second substances to be separated 222 are immobilized on the first separation region 121 and the second separation region 122, respectively.

In another embodiment, there are two separation regions, wherein a Au layer 1211 is manufactured as one separation region, and a glass layer is manufactured as the other separation region using a microelectromechanical process. The surface of the glass layer is modified by chemical agents. The chemical agents do not affect the surfaces of other separation regions. In the present embodiment, the surface of the glass layer is applied with 3-Aminopropyltriethoxysilane (APTES) 41, and then the APTES is bound with glutaraldehyde 42.

Moreover, the synthetic thiol-DNA 51 and amino-DNA 52 are utilized as substances to be separated, and the both DNA has been labeled with fluorescein isothiocyanate (FITC) and carboxy-tetramethylrhodamine (TAMRA), respectively. The thiol-DNA 51 is labeled with the FITC, and the amino-DNA 52 is labeled with the TAMRA to analyze whether the thiol-DNA 51 or amino-DNA 52 is immobilized on the separation region by the specific binding or not.

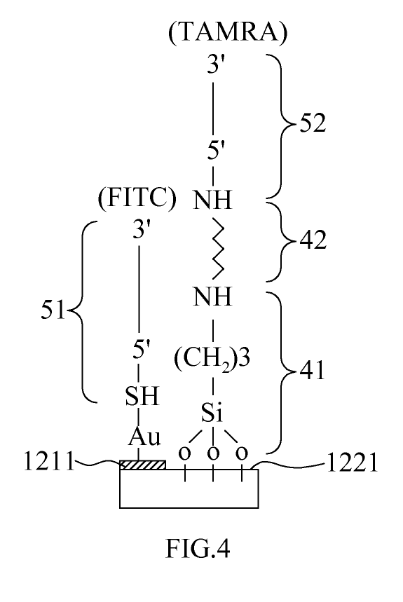

When the mixture solution 21 comprising the thiol-DNA 51 and amino-DNA 52 is dropped on the volatility-type isolation and purification device according to the present invention, the edge of the mixture solution 21 is driven to displace to the center due to the volatilization itself. According to the designed surface of the separation regions, the thiol-DNA 51 is immobilized on the Au layer 1211, which means the thiol-DNA 51 is directly bound with the Au layer 1211. Moreover, the amino-DNA 52 can be retained on the glass surface modified with the chemical agents, as shown in FIG. 4.

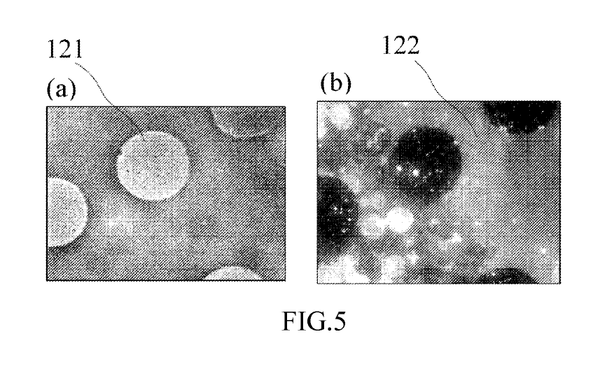

Fluorescent substances are excited by light with a short wavelength and enough energy. For example, the excitation wavelength of the FITC is 488 nm, and the excitation wavelength of the TAMRA is 565 nm. The excited fluorescent substances will emit fluorescence with the long wavelength while returning to the stable energy level. The emission wavelength of the FITC is 515 nm, and the emission wavelength of the TAMRA is 580 nm. A black background on a film is presented because there are not any fluorescent substances to emit. The results of the fluorescence analyzed by the fluorescence microscope show that the emission wavelength of the Au layer 1211 is certainly 518 nm. The emission wavelength of the glass surface 1221 modified with the chemical agents is certainly 580 nm. The images of the results are shown in FIGS. 5 (a) and (b), respectively.

Therefore, the mixture solution can be driven to flow by the driven power of volatilization itself according to the volatility-type isolation and purification device. Then, the mixture solution can be flowed through the designed separation region without any additional powers. Further, the surface of the separation regions comprises the immobilization layers to immobilize the substances to be separated with specific binding so as to achieve the isolation effect.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A volatility-type isolation and purification device, comprising:
a substrate; and
at least one separation region disposed on the substrate, a surface of the at least one separation region comprising at least one immobilization layer;
wherein, a mixture solution comprising at least one substance to be separated is dropped on the at least one separation region, such that the at least one substance to be separated each is immobilized on the immobilization layer respectively by a driving force of the mixture solution.

2. The volatility-type isolation and purification device as claimed in claim 1, wherein the driving force is volatility or hysteresis of the mixture solution.

3. The volatility-type isolation and purification device as claimed in claim 1, wherein the at least one immobilization layer comprises a component selected from the group of an enzyme, an antigen, an antibody, a nucleic acid, a ligand, a receptor, a peptide, a protein, a biological material and a chemical material reacted with the substance to be separated.

4. The volatility-type isolation and purification device as claimed in claim 1, wherein a material of the substrate comprises a silicon, a glass, a nylon, a polymer, or a ceramic.

5. The volatility-type isolation and purification device as claimed in claim 4, wherein the immobilization layer, defined by the substrate, on the separation region is formed by different microstructures or nanostructures.

6. The volatility-type isolation and purification device as claimed in claim 1, wherein a material of the at least one separation region comprises a glass, a nylon, a polymer or a ceramic.

7. The volatility-type isolation and purification device as claimed in claim 6, wherein the material of the at least one separation region further comprises a metal.

8. The volatility-type isolation and purification device as claimed in claim 7, wherein the metal comprises gold, nickel or cobalt.

9. The volatility-type isolation and purification device as claimed in claim 8, wherein a particle size of the metal comprises a microstructure, a nanostructure, or a nano-microstructure.

10. The volatility-type isolation and purification device as claimed in claim 1, wherein a shape of the at least one separation region comprises a circle, an oblong, a triangle, a rectangle, or an irregular shape.

11. The volatility-type isolation and purification device as claimed in claim 1, wherein the at least one separation region comprises a self-assembly monolayer (SAM).

12. The volatility-type isolation and purification device as claimed in claim 1, wherein the at least one substance to be separated comprises DNA, RNA, a peptide, or a protein.
